(19) United States
(12) Patent Application Publication
(10) Pub. No.: US 2015/0097001 A1
(43) Pub. Date: Apr. 9, 2015

(54) MOBILE BEVERAGE CART

(71) Applicant: The Coca-Cola Company, Atlanta, GA (US)

(72) Inventor: Shaun B. Gatipon, Kennesaw, GA (US)

(73) Assignee: The Coca-Cola Company, Atlanta, GA (US)

(21) Appl. No.: 14/504,664

(22) Filed: Oct. 2, 2014

Related U.S. Application Data
(60) Provisional application No. 61/888,656, filed on Oct. 9, 2013.

(51) Int. Cl. B67D 1/08; B67D 1/10; B67D 1/16

(52) U.S. Cl. CPC B67D 1/0891; B67D 1/16; B67D 1/10; B67D 1/0857
USPC 222/108; 222/146.6; 222/144.5

(57) ABSTRACT

A mobile beverage cart is disclosed herein. According to an embodiment, the mobile beverage cart may include a water chiller system and a beverage dispensing system. The beverage dispensing system may include a manifold, at least one product line in communication with the manifold, at least one product container in communication with the at least one product line, an electric pump in communication with the at least one product line, a water line in communication with the water chiller system and the manifold, and a dispensing device in communication with the manifold.

### CROSS-REFERENCE TO RELATED APPLICATIONS

The disclosure claims priority to and the benefit of U.S. provisional patent application No. 61/888,656, filed Oct. 9, 2013, which is hereby incorporated by reference in its entirety.

### FIELD OF THE DISCLOSURE

The disclosure generally relates to a mobile beverage cart and more particularly relates to systems and methods for dispensing one or more beverages from a mobile beverage cart.

### BACKGROUND

Current techniques for staging beverages for large meals at convention centers generally involve filling pitchers with a beverage at a typical beverage dispenser (perhaps located in a kitchen remote from the convention center). The current technique is cumbersome and logistically difficult.

### SUMMARY

Some or all of the above needs and/or problems may be addressed by certain embodiments of the mobile beverage cart disclosed herein. According to an embodiment, the mobile beverage cart may include a water chiller system and a beverage dispensing system. The beverage dispensing system may include a manifold, at least one product line in communication with the manifold, at least one product container in communication with the at least one product line, an electric pump in communication with the at least one product line, a water line in communication with the water chiller system and the manifold, and a dispensing device in communication with the manifold.

Other features and aspects of the mobile beverage cart will be apparent or will become apparent to one with skill in the art upon examination of the following figures and the detailed description. All other features and aspects, as well as other system, method, and assembly embodiments, are intended to be included within the description and are intended to be within the scope of the accompanying claims.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts a water chiller system and a beverage dispensing system of a mobile beverage cart in accordance with one or more embodiments of the disclosure.

FIG. 2 depicts a partially exploded view of a mobile beverage cart in accordance with one or more embodiments of the disclosure.

FIG. 3 depicts a partially exploded view of a mobile beverage cart in accordance with one or more embodiments of the disclosure.

FIG. 4 depicts an upper perspective view of a mobile beverage cart in accordance with one or more embodiments of the disclosure.

FIG. 5 depicts an upper perspective view of a mobile beverage cart in accordance with one or more embodiments of the disclosure.

FIG. 6 depicts an upper perspective view of a mobile beverage cart in accordance with one or more embodiments of the disclosure.

FIG. 7 depicts a top view of a mobile beverage cart in accordance with one or more embodiments of the disclosure.

FIG. 8 depicts a side view of a mobile beverage cart in accordance with one or more embodiments of the disclosure.

### DETAILED DESCRIPTION

Described below are example embodiments of a mobile beverage cart. The mobile beverage cart may be used in a number of industries and applications. One non-limiting example may include the hospitality industry. For example, the mobile beverage cart may be used to fill drinks in ballrooms or conventions centers. Other applications may include sporting events, the aviation industry, or the like. The mobile beverage cart may be used in any suitable application.

Generally speaking, the mobile beverage cart may include a water chiller system and a beverage dispensing system. In certain embodiments, the beverage dispensing system may include a manifold. In some instances, the manifold may be a bar gun manifold. The bar gun manifold may be configured to receive a number of pressurized fluid lines by way of one or more fluid line inlets. In some instances, the bar gun manifold may include one or more metering devices configured to meter the flow of fluid from the pressurized fluid lines.

The beverage dispensing system also may have one or more product lines, one or more product containers, and/or one or more electric pumps. For example, the beverage dispensing system may include a first product line in communication with the bar gun manifold. In some instances, the first product line may provide the bar gun manifold with a first pressurized fluid. For example, one or more first product containers and a first electric pump may be in communication with the first product line. In this manner, a first product stored within the first product container may be pumped from the first product container by the first electric pump to the bar gun manifold. Similarly, the beverage dispensing system may include a second product line in communication with the bar gun manifold. In some instances, the second product line may provide the bar gun manifold with a second pressurized fluid. For example, one or more second product containers and a second electric pump may be in communication with the second product line. In this manner, a second product stored within the second product container may be pumped from the second product container by the second electric pump to the bar gun manifold. Additional (or fewer) products, product lines, and/or electric pumps may be incorporated into the beverage dispensing system. In some instances, the product containers may be bag-in-box (BIB) beverage containers.

The beverage dispensing system also may include a water line in communication with the water chiller system and the bar gun manifold. In some instances, the water line may supply the bar gun manifold with cold water. For example, the water line may be in communication with a water source via a spigot, a faucet, a nozzle, or the like. In some instances, the water source may include water provided by a municipality or otherwise. The water source may provide water to the water line under pressure, and/or the water line may include a water pump. In certain embodiments, the water line may be connected to the water source by a quick connect device. In this manner, the water line may be quickly attached and detached from the water source. The water line may pass through the water chiller system, which may cool the water flowing through the water line. In some instances, a water filter may be incorporated into the water line.

In certain embodiments, a beverage dispensing device may be in communication with the bar gun manifold. In some instances, the beverage dispensing device may be a bar gun. The bar gun may be configured to dispense a beverage from the first product line, the second product line, the water line, and/or a combination thereof. That is, a beverage dispensed by the bar gun may be a mixture of the first product from the first product line, the second product from the second product line, or the water line. In some instances, the bar gun may be a three button bar gun. Other types of beverage dispensing devices may be used, including taps, nozzles, valves, etc.

In certain embodiments, the water chiller system may include an ice bath and a refrigeration system. The refrigeration system may be configured to cool the ice bath. For example, the refrigeration system may be configured to cool the ice bath such that ice is at least partially formed within the ice bath. The water line may be in communication with the ice bath. In this manner, water flowing through the water line may be cooled by the ice bath. The ice bath may act as a heat transfer device between the refrigeration system and the water line. In some instances, the refrigeration system may include a vapor compression cycle system. For example, the refrigeration system may include a compressor, a condenser, an expansion valve, and an evaporator. In some instances, the evaporator may be positioned about the ice bath. Other refrigeration systems may also be used herein.

The mobile beverage cart may include a number of compartments for housing, storing, stowing, and/or transporting the various components of the mobile beverage cart. For example, the mobile beverage cart may include a product container compartment configured to house the one or more product containers therein (such as the first product containers and the second product containers). In some instances, the product container compartment may include a top shelf and a bottom shelf. In this example embodiment, the first product containers may be positioned on the top shelf, and the second product containers may be positioned on the bottom shelf, or vice versa. One or more access panels or doors may provide access to the product container compartment.

The mobile beverage cart may include a water chiller system compartment configured to house the water chiller system therein. In certain embodiments, the water chiller system compartment may be positioned adjacent to the product container compartment. One or more access panels or doors may provide access to the water chiller system compartment. The water chiller system compartment may include an air inlet and an exhaust outlet for the refrigeration system.

The mobile beverage cart may include a utility compartment configured to at least partially house a power supply, the bar gun manifold, the first electric pump, the second electric pump, the water filter, and/or at least a portion of the first product line, the second product line, and/or the water line. One or more access panels or doors may provide access to the utility compartment.

In certain embodiments, the mobile beverage cart may include a drain pan disposed about a top portion of the mobile beverage cart. The drain pan may include a lip. The drain pan may facilitate the filling of one or more cups, glasses, mugs, etc., with a beverage. For example, a user of the mobile beverage cart may place one or more cups within the drain pan and fill them with ice, water, and/or a beverage. In some instances, the drain pan may include two spaced apart rails configured to receive a crate (such as a glassware crate) thereon. That is, the glassware crate may rest on the two rails. In this manner, a user may place one or more glassware crates on the two rails and fill the glasses within the glassware crate with ice, water, and/or a beverage.

In certain embodiments, the drain pan may include a drainage aperture disposed between the two rails. The drainage aperture may drain spillage within the drain pan. In some instances, a removable drainage reservoir may be in communication with the drainage aperture. The removable drainage reservoir may be a container, a bucket, a vessel, or the like configured to receive and store wastewater/beverage from the drain pan. In some instances, the removable drainage reservoir may be stowed in a drainage compartment. One or more access panels or doors may provide access to the drainage compartment. In other instances, the removable drainage reservoir may nest within the drainage compartment flush with the exterior of the mobile beverage cart such that a door is not necessary.

In some instances, the mobile beverage cart may include a bar gun holster coupled to the drain pan. The bar gun holster may be disposed at any location about the mobile beverage cart. As its name implies, the bar gun holster is configured to stow the bar gun.

The mobile beverage cart also may include a removable centering tray. The removable centering tray may be used to fill glasses with ice, water, and/or a beverage. For example, the removable centering tray may be placed on top of a glassware crate positioned between the rails of the drain pan. The removable centering tray may include a number of openings that correspond to the openings of the beverage containers in the glassware crate. The removable centering tray may be stowed in a centering tray holster configured to receive the removable centering tray. The centering tray holster may be disposed at any location about the mobile beverage cart.

To facilitate movement of the mobile beverage cart, a number of wheels (or swivels) may be positioned about a bottom of the cart. Further, the mobile beverage cart may include one or more handles for maneuvering the mobile beverage cart.

These and other embodiments of the mobile beverage cart will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

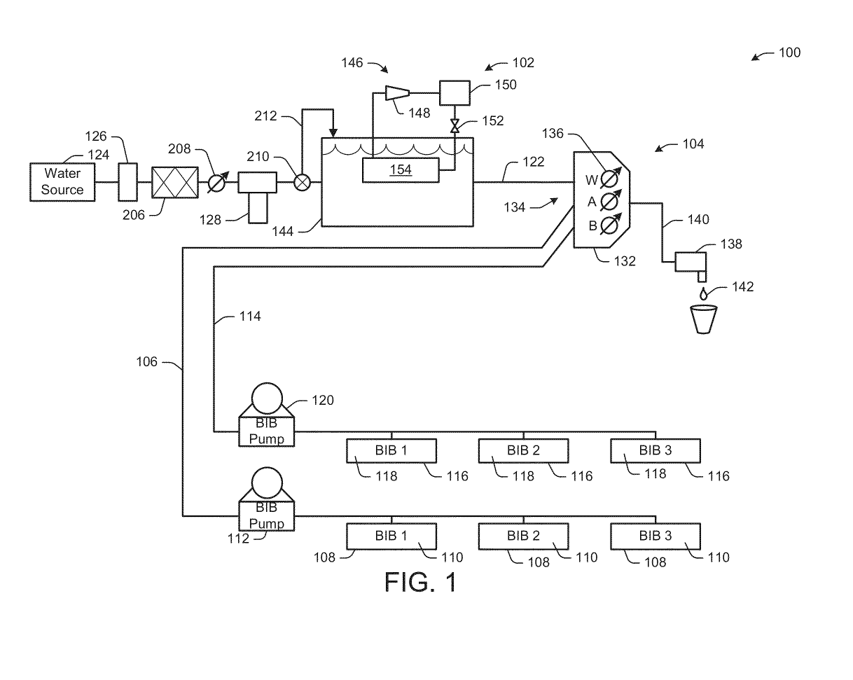

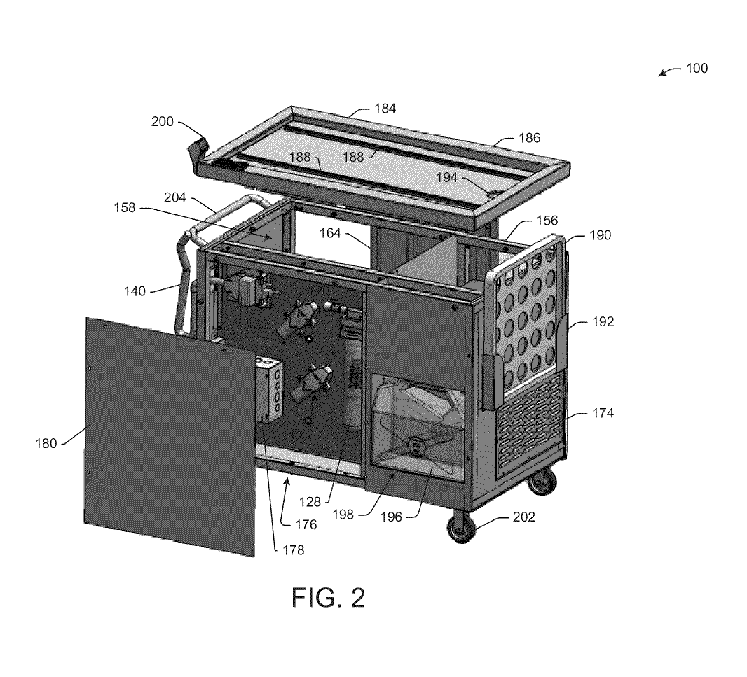

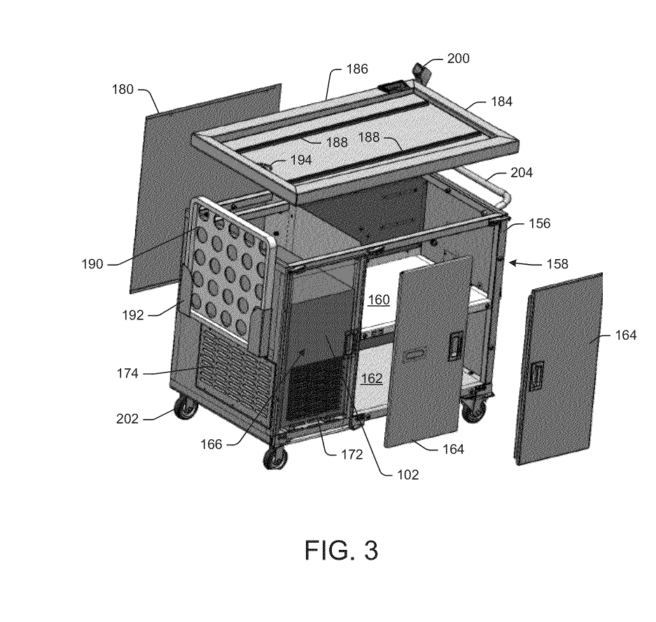

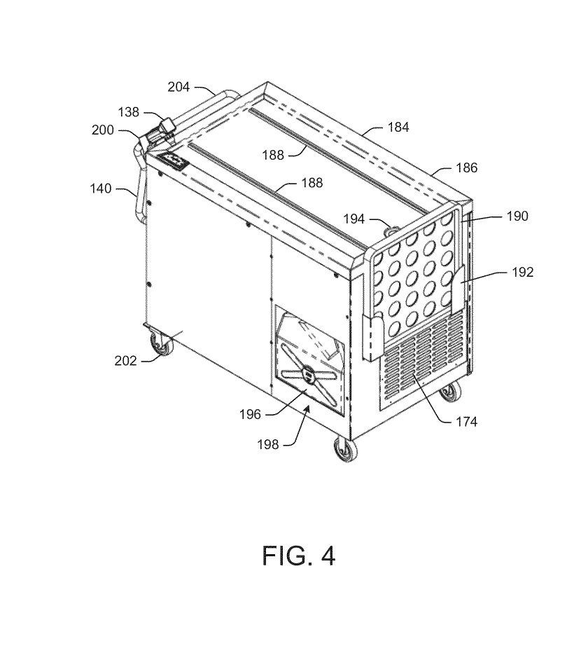

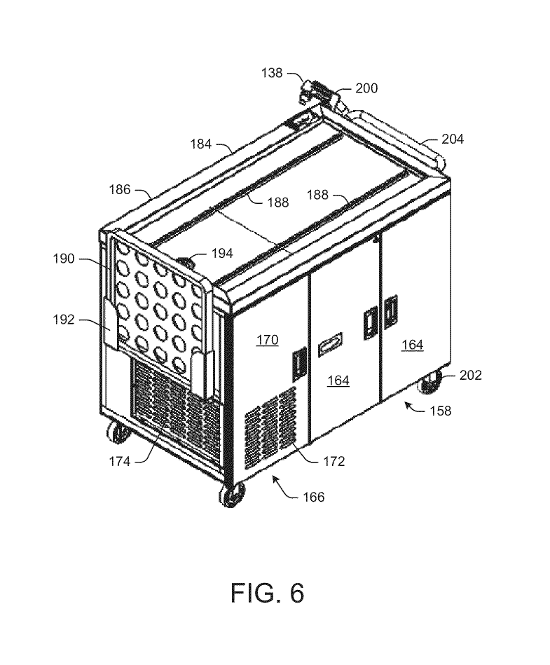

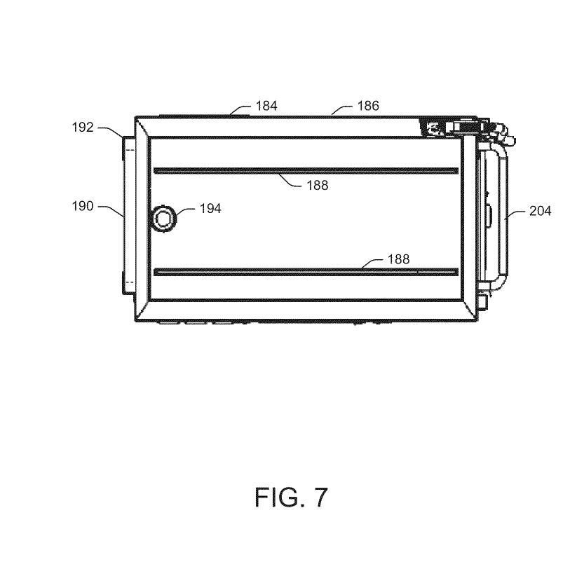

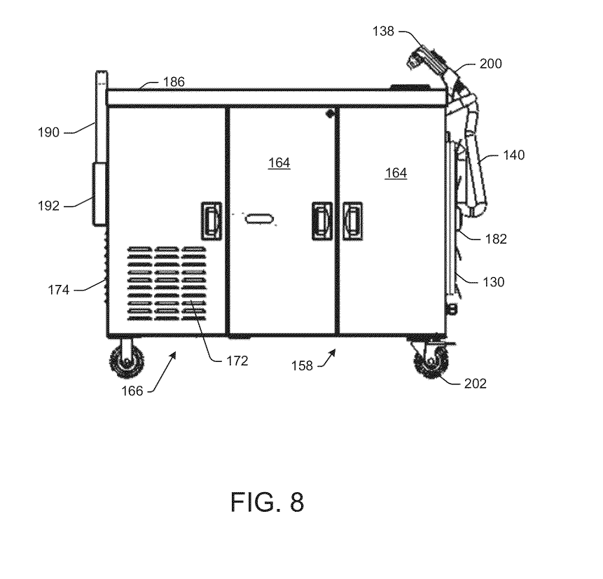

Turning now to the drawings, FIGS. 1-8 depict a mobile beverage cart 100 in accordance with one or more embodiments of the disclosure. The mobile beverage cart 100 may include, among other things, a water chiller system 102 and a beverage dispensing system 104.

The beverage dispensing system 104 may include one or more product lines, one or more product containers, and/or one or more electric pumps. For example, the beverage dispensing system 104 may include a first product line 106. The first product line 106 may be any conduit suitable for fluid flow. A number of first product containers 108 may be in communication with the first product line 106. The first product containers 108 may contain a first product 110 therein. In some instances, the first product containers 108 may be BIB containers. The first product containers 108 may contain any beverage therein, including, but not limited to, ready-to-drink beverages, syrups, concentrates, pre-mixes, or the like. In some instances, any non-carbonated beverage may be used. In an example embodiment, the first product containers 108 may contain a tea (e.g., sweet or unsweet), a lemonade, a limeade, a sports beverage, a punch, a juice, enhanced water, or the like. The first product line 106 may include a first electric pump 112. The first electric pump 112 may be configured to pump the first product 110 from the first product containers 108 through the first product line 106.

The beverage dispensing system 104 may include a second product line 114. The second product line 114 may be any conduit suitable for fluid flow. A number of second product containers 116 may be in communication with the second product line 114. The second product containers 116 may contain a second product 118 therein. In some instances, the second product containers 116 may be BIB containers. The second product containers 116 may contain any beverage therein including, but not limited to, ready-to-drink beverages, syrups, concentrates, pre-mixes, or the like. In some instances, any non-carbonated beverage may be used. In an example embodiment, the second product containers 116 may contain a tea (e.g., sweet or unsweet), a lemonade, a limeade, a sports beverage, a punch, a juice, enhanced water, or the like. The second product line 114 may include a second electric pump 120. The second electric pump 120 may be configured to pump the second product 118 from the second product containers 116 through the second product line 114. Additional (or fewer) products, product lines, and/or electric pumps may be incorporated into the beverage dispensing system 104.

In certain embodiments, because the first product 110 and the second product 118 may be non-carbonated beverages, a carbon dioxide (CO₂) container may be omitted from the mobile beverage cart 100 assembly. Instead, the first electric pump 112 and the second electric pump 120 may create a pressure differential in the first product line 106 and the second product line 114, respectively. The absence of CO₂ enables the mobile beverage cart to be used in a wide variety of settings. Moreover, the mobile beverage cart avoids delays associated with refilling or swapping out CO₂ containers.

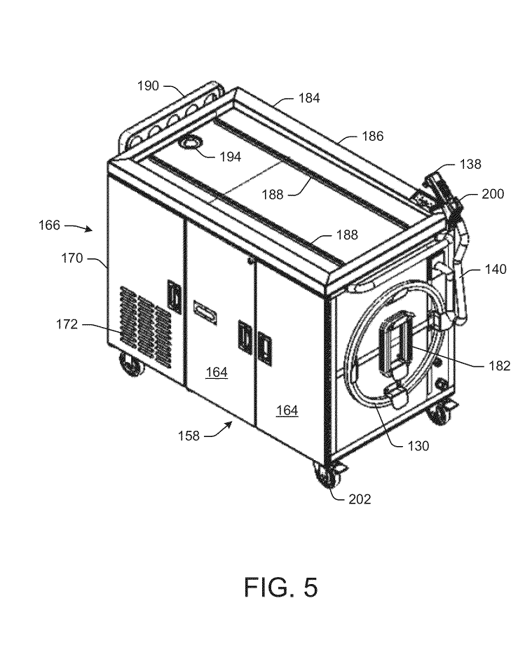

The beverage dispensing system 104 may include a water line 122. The water line 122 may be in communication with a water source 124 by way of a spigot, a faucet, a nozzle, or the like. In certain embodiments, the water line 122 may be connected to the water source 124 by a quick connect device 126. In this manner, the water line 122 may be quickly attached and detached from the water source 124. In some instances, the water source 124 may include water provided by a municipality or otherwise. The water source 124 may provide water to the water line 122 under pressure. In some instances, the water line 122 may include a water pump (not shown). In certain embodiments, a water filter 128 may be incorporated into the water line 122. In some instances, the water line 122 may include a hose reel 130 (shown in FIG. 5) for connecting the water line 122 to the water source 124. The water line 122 may include any conduit suitable for fluid flow therethrough.

The beverage dispensing system 104 may include a bar gun manifold 132. The bar gun manifold 132 may be configured to receive any number of pressurized fluid lines at one or more fluid line inlets 134. For example, the first product line 106, the second product line 114, and the water line 122 may be in communication with the bar gun manifold 132. In some instances, the bar gun manifold 132 may include one or more metering devices 136 configured to meter the flow of fluid from the first product line 106, the second product line 114, and the water line 122.

The beverage dispensing system 104 may include a bar gun 138 in communication with the bar gun manifold 132. In some instances, a bar gun line 140 may fluidly couple the bar gun manifold 132 to the bar gun 138. The bar gun 138 may be configured to dispense a beverage 142 from the first product line 106, the second product line 114, the water line 122, and/or a combination thereof. That is, the beverage 142 dispensed by the bar gun 138 may be a mixture of the first product 110 from the first product line 106, the second product 118 from the second product line 114, and/or the water from the water line 122. In certain embodiments, the bar gun 138 may be configured to mix the first product 110 from the first product line 106, the second product 118 from the second product line 114, the water from the water line 122, and/or a combination thereof to form the beverage 142. That is, mixing of the fluids may take place at the bar gun 138. In some instances, the bar gun 138 may be a three button bar gun. In an example embodiment, the bar gun 138 may be configured to dispense the beverage 142 at about three ounces per second, although other flow rates are possible. Other types of beverage dispensing devices may be used.

The water line 122 may be in communication with the water chiller system 102. In this manner, the water chiller system 102 may cool (or chill) the water flowing through the water line 122. The water chiller system 102 may include an ice bath 144 and a refrigeration system 146. The ice bath 144 may include water therein. The refrigeration system 146 may be configured to cool the water within the ice bath 144. For example, the refrigeration system 146 may be configured to cool the water within the ice bath 144 such that ice at least partially forms within the ice bath 144. The water line 122 may pass through the ice bath 144, thereby cooling the water flowing through the water line 122. For example, the water in the water line 122 may enter the ice bath 144 at an ambient temperature from the water source 124 and exit the ice bath 144 as cold water. The ice bath 144 may act as a heat transfer device between the refrigeration system 146 and the water line 122. In some instances, the refrigeration system 146 may include a vapor compression cycle system. For example, the refrigeration system 146 may include a compressor 148, a condenser 150, an expansion valve 152, and an evaporator 154. In some instances, the evaporator 154 may be at least partially positioned about the ice bath 144 so as to form ice therein. Other refrigeration systems may also be used herein.

In some instances, the water line 122 may include an inline strainer 206. The inline strainer 206 may be configured to remove large (or small) particulates from the water. In addition, in certain embodiments, the water line 122 may include a pressure regulator 208 configured to regulate the pressure of the water within the water line 122. In some instances, an ice bath water line 212 may be in communication with the water line 122 by way of an ice bath water valve 210. In this manner, the ice bath 144 may be filled and refilled with water by way of the water valve 210 and the ice batch water line 212.

In certain embodiments, the first product line 106 and the second product line 114 may be in communication with the water chiller system 102. For example, the first product line 106 and the second product line 114 may pass through the ice bath 144. In this manner, the first product 110 within the first product line 106 and the second product 118 within the second product line 114 may be cooled (or chilled) by the ice bath 144 before entering the bar gun manifold 132. In another embodiment, the first product 110 within the first product line 106 and the second product 118 within the second product line 114 may be provided to the bar gun manifold 132 at an ambient temperature.

The water chiller system 102 and the beverage dispensing system 104 may be housed within the mobile beverage cart 100. For example, the mobile beverage cart 100 may include a frame 156. The frame 156 may define a number of compartments within the mobile beverage cart 100. Some of the compartments may be at least partially enclosed by one or more panels. For example, the mobile beverage cart 100 may include a number of compartments for housing, storing, stowing, and/or transporting the various components described herein.

In an example embodiment, the mobile beverage cart 100 may include a product container compartment 158 configured to house the first product containers 108 and the second product containers 116. In some instances, the product container compartment 158 may include a top shelf 160 and a bottom shelf 162. In this example embodiment, the first product containers 108 may be positioned on the top shelf 160, and the second product containers 116 may be positioned on the bottom shelf 162, or vice versa. One or more access panels or doors 164 may provide access to the product container compartment 158. Additional product shelves may be incorporated to accommodate additional product lines and product containers.

The water chiller system 102 may be at least partially housed within a water chiller system compartment 166. In certain embodiments, the water chiller system compartment 166 may be positioned adjacent to the product container compartment 158. For example, the water chiller system compartment 166 and the product container compartment 158 may abut or share a comment wall. One or more access panels or doors 170 may provide access to the water chiller system compartment 166. The water chiller system compartment 166 may include an air inlet 172 and an exhaust outlet 174 for the water chiller system 102. The water chiller system 102 may include duct work within the water chiller system compartment 166 between the air inlet 172 and the exhaust outlet 174 so as to prevent (or minimize) undesirable heat transfer between the water chiller system 102 and other components of the mobile beverage cart 100. In some instances, the water chiller system compartment 166 and the product container compartment 158 may include insulation.

In some instances, the mobile beverage cart 100 may include a utility compartment 176 configured to at least partially house a power supply 178, the bar gun manifold 132, the first electric pump 112, the second electric pump 120, the water filter 128, and/or at least a portion of the first product line 106, the second product line 114, and/or the water line 122. One or more access panels or doors 180 may provide access to the utility compartment 176. The power supply 178 may provide power to the electric pumps and/or the refrigeration system. The power supply 178 may include a power cord reel 182. In some instances, the power supply 178 may include one or more batteries.

In certain embodiments, the mobile beverage cart 100 may include a drain pan 184 disposed about a top portion of the frame 156. The drain pan 184 may include a lip 186 about its periphery. The drain pan 184 may collect spillage caused by filling one or more cups, glasses, mugs, etc., with the beverage 142. For example, a user of the mobile beverage cart 100 may place one or more cups (or other beverage containers) within the drain pan 184 and fill them with ice, water, and/or a beverage from the bar gun 138.

In some instances, the drain pan 184 may include two spaced apart rails 188 configured to receive one or more crates (such as glassware crates) thereon. That is, the glassware crates may rest on the two rails 188. In this manner, a user may place one or more glassware crates on the two rails 188 and fill the beverage containers within the glassware crate with ice, water, and/or a beverage. The rails 188 may raise the glassware crates above the drain pan 184 and allow for overfill spillage or waste to evacuate to the drain. To facilitate the dispensing and filling of beverages, the mobile beverage cart 100 also may include a removable centering tray 190. The removable centering tray 190 may be placed on top of the glassware crates. The removable centering tray 190 may include a number of openings that correspond to the openings of the beverage containers in the glassware crates. The removable centering tray 190 may be stowed in a centering tray holster 192 configured to receive the removable centering tray 190. The centering tray holster 192 may be disposed at any location about the mobile beverage cart 100.

In certain embodiments, the drain pan 184 may include a drainage aperture 194 disposed between the two rails 188. The drainage aperture 194 may drain spillage within the drain pan 184. In some instances, a removable drainage reservoir 196 may be in fluid communication with the drainage aperture 194. The removable drainage reservoir 196 may be a container, a bucket, a vessel, or the like configured to receive and store wastewater/beverage from the drain pan 184. In some instances, the removable drainage reservoir 196 may be stowed in a drainage compartment 198. One or more access panels or doors may provide access to the drainage compartment 198. In other instances, the removable drainage reservoir 196 may nest within the drainage compartment 198 flush with the exterior of the mobile beverage cart 100 such that a door is not necessary. When the removable drainage reservoir 196 is filled, it may be removed, emptied, and returned.

In some instances, the mobile beverage cart 100 may include a bar gun holster 200. The bar gun holster 200 may be disposed at any location about the mobile beverage cart 100. The bar gun holster 200 may be configured to stow the bar gun 138 therein.

To facilitate movement of the mobile beverage cart 100, the frame 156 may include a number of wheels (or swivels) 202. Further, the frame 156 may include one or more handles 204 for maneuvering the mobile beverage cart 100.

In an example embodiment, the mobile beverage cart 100 may be used to stage non-carbonated drinks for a large meal in a convention center. For example, the mobile beverage cart 100 may be transported (e.g., rolled) to the convention center floor near the serving tables. The water line 122 may be coupled to the water source 124 using the quick connect device 126. A user may then place one or more glassware crates on top of the mobile beverage cart 100 between the rails 188 in the drain pan 184. The user may then remove the centering tray 190 from the centering tray holster 192 and place the centering tray 190 on top of the glassware crate. The user may then fill the glassware with ice and/or remove the bar gun 138 from the bar gun holster 200 and fill the glassware with a non-carbonated beverage formed from the first product 110, the second product 118, the water, or a combination thereof. Any spillage during this process may drain to the drainage reservoir 196 via the drainage aperture 194.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A mobile beverage cart, comprising:
a water chiller system; and
a beverage dispensing system, comprising:
a bar gun manifold;
a first product line in communication with the bar gun manifold;
at least one first product container in communication with the first product line;
a first electric pump in communication with the first product line;
a second product line in communication with the bar gun manifold;
at least one second product container in communication with the second product line;
a second electric pump in communication with the second product line;
a water line in communication with the water chiller system and the bar gun manifold; and
a bar gun in communication with the bar gun manifold.

2. The mobile beverage cart of claim 1, wherein the water chiller system comprises:
an ice bath in communication with the water line; and
a refrigeration system in communication with the ice bath.

3. The mobile beverage cart of claim 2, wherein the refrigeration system comprises a vapor compression cycle system.

4. The mobile beverage cart of claim 1, further comprising a water filter in communication with the water line.

5. The mobile beverage cart of claim 1, wherein the water line comprises a quick connect device.

6. The mobile beverage cart of claim 1, further comprising a product container compartment configured to house the at least one first product container and the at least one second product container therein.

7. The mobile beverage cart of claim 1, further comprising a water chiller system compartment configured to at least partially house the water chiller system therein.

8. The mobile beverage cart of claim 7, wherein water chiller system compartment comprises:
an air inlet; and
an exhaust outlet.

9. The mobile beverage cart of claim 1, further comprising a drain pan disposed about a top portion of the mobile beverage cart.

10. The mobile beverage cart of claim 9, wherein the drain pan comprises two spaced apart rails configured to receive a crate thereon.

11. The mobile beverage cart of claim 10, wherein the drain pan comprises a drainage aperture disposed between the two rails.

12. The mobile beverage cart of claim 11, further comprising a removable drainage reservoir in communication with the drainage aperture.

13. The mobile beverage cart of claim 12, further comprising a drainage compartment configured to house the removable drainage reservoir therein.

14. The mobile beverage cart of claim 1, further comprising a utility compartment configured to house at least one of: a power supply; the bar gun manifold; the first electric pump; the second electric pump; or the water filter.

15. The mobile beverage cart of claim 1, further comprising a bar gun holster coupled to the drain pan.

16. The mobile beverage cart of claim 1, further comprising a removable centering tray.

17. The mobile beverage cart of claim 16, further comprising a centering tray holster configured to stow the removable centering tray.

18. The mobile beverage cart of claim 1, further comprising:
a plurality of wheels; and
at least one handle.

19. A mobile beverage cart, comprising:
a water chiller system; and
a beverage dispensing system, comprising:
a manifold;
at least one product line in communication with the manifold;
at least one product container in communication with the at least one product line;
an electric pump in communication with the at least one product line;
a water line in communication with the water chiller system and the manifold; and
a dispensing device in communication with the manifold.

20. A mobile beverage cart, comprising:
a water chiller system;
a beverage dispensing system;
a drain pan disposed about a top portion of the mobile beverage cart, wherein the drain pan comprises two spaced apart rails configured to receive a crate thereon, wherein the drain pan comprises a drainage aperture disposed between the two rails;
a removable drainage reservoir in communication with the drainage aperture; and
a drainage compartment configured to house the removable drainage reservoir therein.
